(19) United States
(12) Patent Application Publication
(10) Pub. No.: US 2009/0002530 A1
(43) Pub. Date: Jan. 1, 2009

(54) APPARATUS AND METHOD FOR PROCESSING IMAGES

(75) Inventors: Emi Arai, Tsukuba-shi (JP); Yuji Itoh, Tsukuba-shi (JP)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 12/140,049

(22) Filed: Jun. 16, 2008

Related U.S. Application Data
(60) Provisional application No. 60/946,440, filed on Jun. 27, 2007.

(51) Int. Cl. H04N 5/335

(52) U.S. Cl. 348/294; 348/E05.091

(57) ABSTRACT

The mixing of high-gain and low-gain outputs of a wide dynamic range image sensor uses relationship parameter estimation according to linear regression; and the mixed output is adaptively filtered for noise gap reduction.

### CROSS-REFERENCE TO RELATED APPLICATIONS

This application claims priority from provisional application No. 60/60/946,440, filed Jun. 27, 2007 which is herein incorporated by reference.

### BACKGROUND OF THE INVENTION

The present invention relates to digital video signal processing, and more particularly to architectures and methods for digital camera front-ends.

Imaging and video capabilities have become the trend in consumer electronics. Digital cameras, digital camcorders, and video cellular phones are common, and many other new gadgets are evolving in the market. Advances in large resolution CCD/CMOS sensors coupled with the availability of low-power digital signal processors (DSPs) has led to the development of digital cameras with both high resolution image and short audio/visual clip capabilities. The high resolution (e.g., sensor with a 2560×1920 pixel array) provides quality offered by traditional film cameras.

FIGS. 3a-3b show typical functional blocks for digital camera control and image signal processing (ISP) also called the “image pipeline”. The automatic focus, automatic exposure, and automatic white balancing are referred to as the 3A functions; and the image signal processing includes functions such as color filter array (CFA) interpolation, gamma correction, color space conversion, and JPEG/MPEG compression/decompression (JPEG for single images and MPEG for video clips). Note that the typical color CCD/CMOS sensor consists of a rectangular array of photosites (corresponding to pixels in an image) with each photosite covered by a single-color filter (the CFA): typically, red, green, or blue filters are used. In the commonly-used Bayer pattern CFA one-half of the photosites are green, one-quarter are red, and one-quarter are blue. That is, each photosite in the sensor detects the incident light amplitude of an input scene for its color, and the sensor output provides a Bayer-pattern image with single-color pixels corresponding to the photosite locations. Subsequent CFA interpolation provides the two other color amplitudes for each pixel to give the full-color image of the input scene.

In most cases, the initial data captured through the camera lens suffers low contrast, insufficient or excessive exposure, and irregular colors. The 3A component technologies are designed to: maximize contrast (AF), obtain an adequate exposure (AF), and correct irregular colors (AWB) in an automatic fashion.

Gamma correction is the name of an interan adjustment applied to compensate for the non-linearities in imaging systems, in particular that of the CRT/TFT monitors and printers. A gamma characteristic is a power-law relationship that approximates the relationship between the encoded luminance in a rendering system and the actual desired image brightness. A cathode ray tube (CRT), for example, converts a signal to light in a non-linear way because the electron gun it contains is a non-linear device. To compensate for such non-linear effects, the inverse transfer function, often refereed as gamma correction, is applied prior to encoding so that the end-to-end response is linear. In other words, the transmitted signal is deliberately distorted so that, after it has been distorted again by the display device, the viewer sees the correct brightness.

The color space conversion functions implement features that change the way that colors are represented in images. Today's devices represent colors in many different ways. In digital camera applications, YUV color space dominates as it is supported by compression standards, such as JPEG and MPEG, that constitute an essential component for the applications. In this context, the color space conversion converts image signals to YUV from the color space of the captured image, such as RGB. The conversion is usually performed by using a 3×3 transform matrix.

The pre-processing stage in FIG. 3a is composed of edge enhancement, false color correction, chroma format conversion, etc. The edge enhancement and false color correction are intended to improve subjective image quality. They are optional, but most recent products support these functionalities. On the other hand, the chroma format conversion is rather essential as image format needs to be converted from YUV 4:4:4 to YUV 4:2:2 or YUV 4:2:0 that is used in the JPEG and MPEG standards. The ISP ends with this pre-processing block.

Once the ISP is done, the only remaining block in encoder (or recorder) is compression, which varies depending on applications. As for digital cameras, for instance, JPEG is a mandatory compression codec whereas MPEG, some lossless codec, and even proprietary schemes are often employed.

Various wide dynamic range (WDR) CMOS sensor architectures have been proposed to overcome the limited (60-70 dB) dynamic range of CCD and CMOS sensors. For example, Massari et al, A 100 dB Dynamic-Range CMOS Vision Sensor with Programmable Image Processing and Global Feature Extraction, 42 IEEE JSSC 647 (March 2007) incorporates analog signal processing at each photosite (pixel). And U.S. Pat. No. 7,026,596 has two photodiodes and circuitry for each pixel: one with low-sensitivity (low-gain) for bright conditions and one with high-sensitivity (high-gain) for low-light conditions. That is, a pixel may include a high-gain cell (denoted S1) plus a low-gain cell (denoted S2). The sensor gain curve that represents the relationship between output signal against incoming light intensity is depicted in FIG. 2a, where [e−] and [LSB] denote electrons and least significant bit, and represent units of input light intensity and sensor output signal, respectively. The gain curves of S1 and S2 are both designed to be linear over an entire dynamic range. Therefore, take S1 and S2 to have linear gain factors ₁ and ₂ (both in units of [LSB/e−]), respectively. As its name implies, S1 has larger gain than S2 and so ₁ is greater than ₂, Both S1 and S2, however, have the same output saturation point, i.e., MaxRaw. Call such a pair of cells (S1, S2) which comprise a pixel a “collocated pair”, and a pixel array of such pixels constitutes a WDR image sensor. Therefore, the WDR sensor has twice as many sensing cells as ordinary image sensors; and when each of the cells has an output, the WDR sensor can output data for two images, one from high-gain cells and one from low-gain cells.

FIG. 2b shows the main concept of how such a device can achieve wide dynamic range. Here let switching point P_{SW} denote the minimum input light that yields MaxRaw using high sensitivity cell S1. Presume that a conventional image sensor which only has S1 receives light whose intensity is larger than P_{SW}; then according to the S1 gain curve, the output signal saturates after applying the gain factor ₁ to the light intensity P_{SW}. Thus, the conventional sensor outputs MaxRaw for incoming light whose intensity equals or exceeds P_{SW}, which is referred to as white washout. In a region of an image where white washout takes place, precise gray level variations in the output signal are lost and all of the pixels are represented by MaxRaw, i.e., white. The white washout is among the major shortcomings of conventional image sensors. If we recursively capture images of a scene (e.g., a scene with static objects), we may be able to gradually tune gain-related parameters of the sensor for the excessive incoming light so as to avoid white washout. Such workarounds include: (1) increased shutter speed (i.e., shorter exposure time), (2) decreased iris opening, and (3) decreased gain factor of analog gain amplifier. However, these workarounds cannot be applied to dynamic scenes where either object or light conditions (source and path) varies with time. A similar scenario holds for black washout, which is the opposite case to white washout, i.e., insufficient light.

The WDR sensor equipped with both S1 and S2 cells can better deal with white washout and black washout. Theoretically, the dynamic range of a WDR sensor is (=₁/₂) times as wide as that of conventional image sensors equipped with only S1 cells. Given, the S2 cell output signal multiplied by, which is called the “projected S2 signal” and is represented by the dotted line in FIG. 2b, can be a decent predictor of the true S1 output signal below P_{SW}. Below the S1 saturation point, we should use the S1 signal because S1 has a higher SNR than S2. Here let f₁(t) and f₂(t) denote the output signal level of S1 and S2, respectively, as a function of incoming light intensity t (in units of [e−]). The output of the WDR sensor, denoted by F(t), is expressed by:

$$\begin{matrix}F ( t ) = {f}_{1} ( t ) & if t < {P}_{SW} \\ = {f}_{2} ( t ) + & otherwise\end{matrix}$$

where and denote gradient and offset, respectively, of the relationship between the signals of collocated S1 and S2. Note that and typically would be computed from actual data of a WDR sensor (or a sample of WDR sensors) during testing, while a target would be fixed at design time.

### SUMMARY OF THE INVENTION

The present invention provides mixing of high-gain and low-gain signals from a wide dynamic range sensor with mixing parameter estimation and/or adaptive noise gap filtering.

### BRIEF DESCRIPTION OF THE DRAWINGS

FIG. 1a-1d illustrate a method and functions of preferred embodiment mixings of high-gain and low-gain.

FIG. 2a-2b illustrate wide dynamic range sensor characteristics.

FIG. 3a-3d show image sensor processing, a processor, and network communications.

FIG. 4 shows pixel map indices.

FIGS. 5a-5c and 6a-6b illustrate adaptive filtering in pixel neighborhoods.

### DESCRIPTION OF THE PREFERRED EMBODIMENTS

### 1. Overview

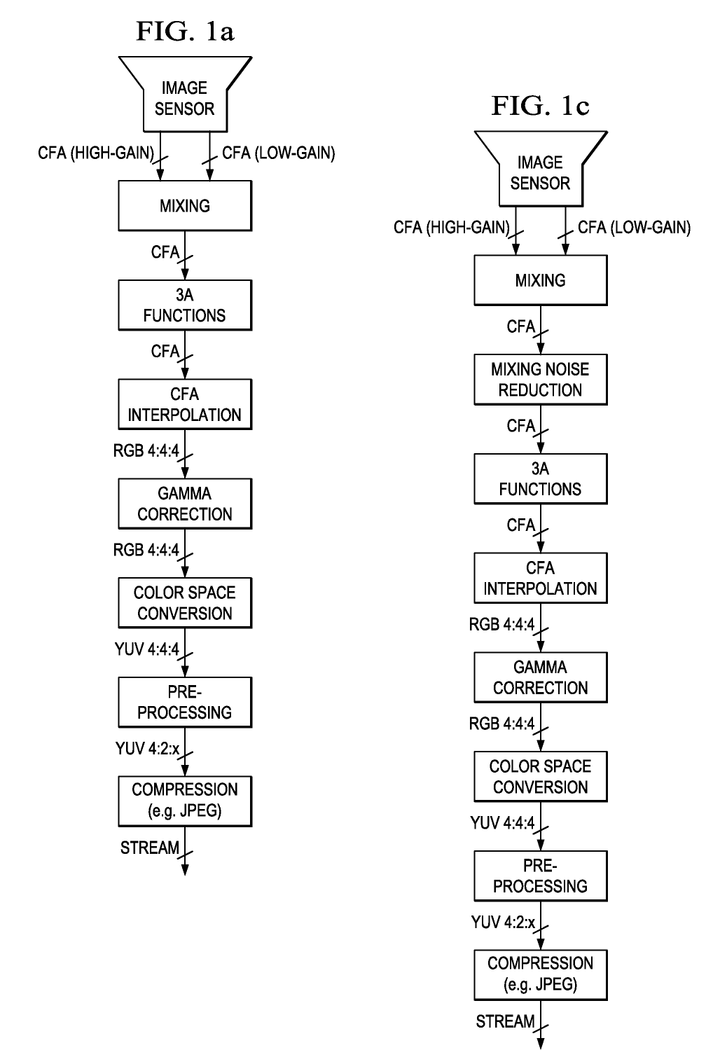

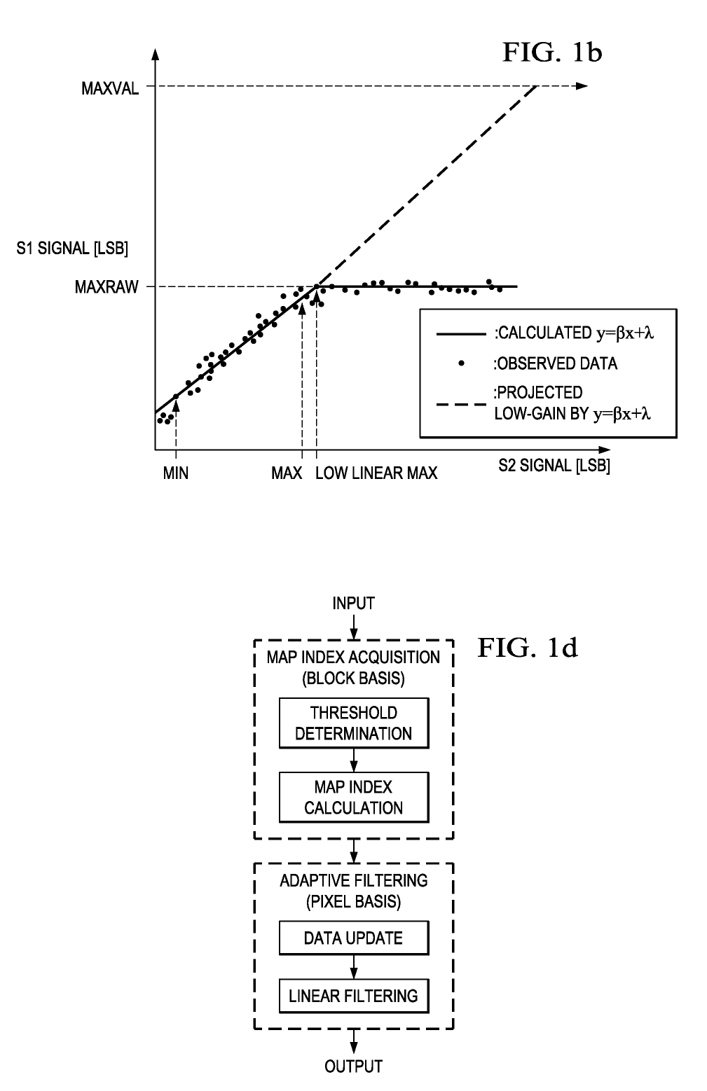

Preferred embodiment methods of mixing high-gain and low-gain signals from a wide dynamic range sensor include estimation of mixing parameters and/or adaptive noise gap filtering. FIG. 1b illustrates parameter estimation and FIG. 1d shows adaptive noise gap filtering.

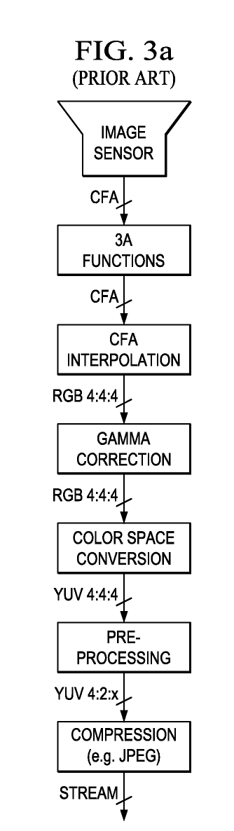

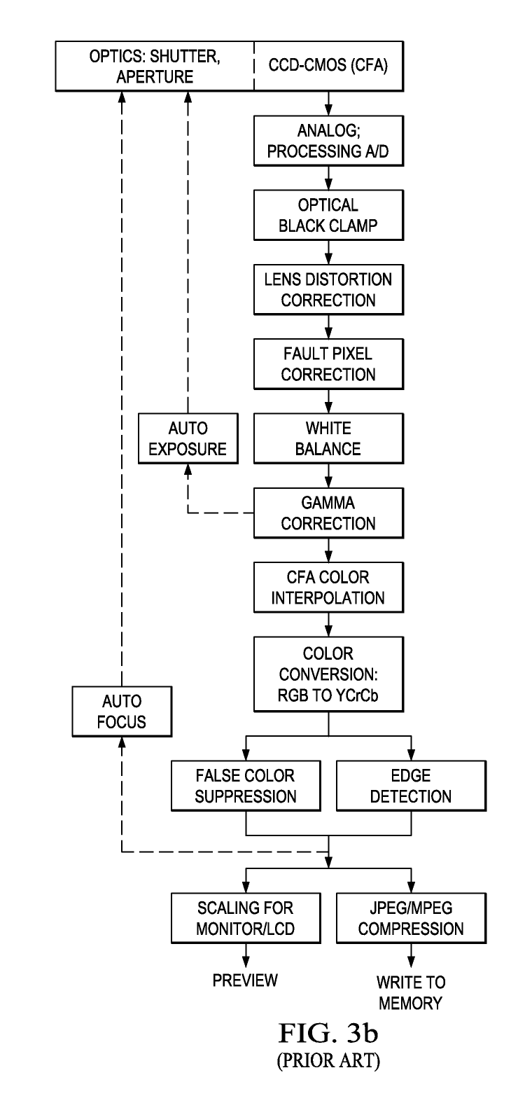

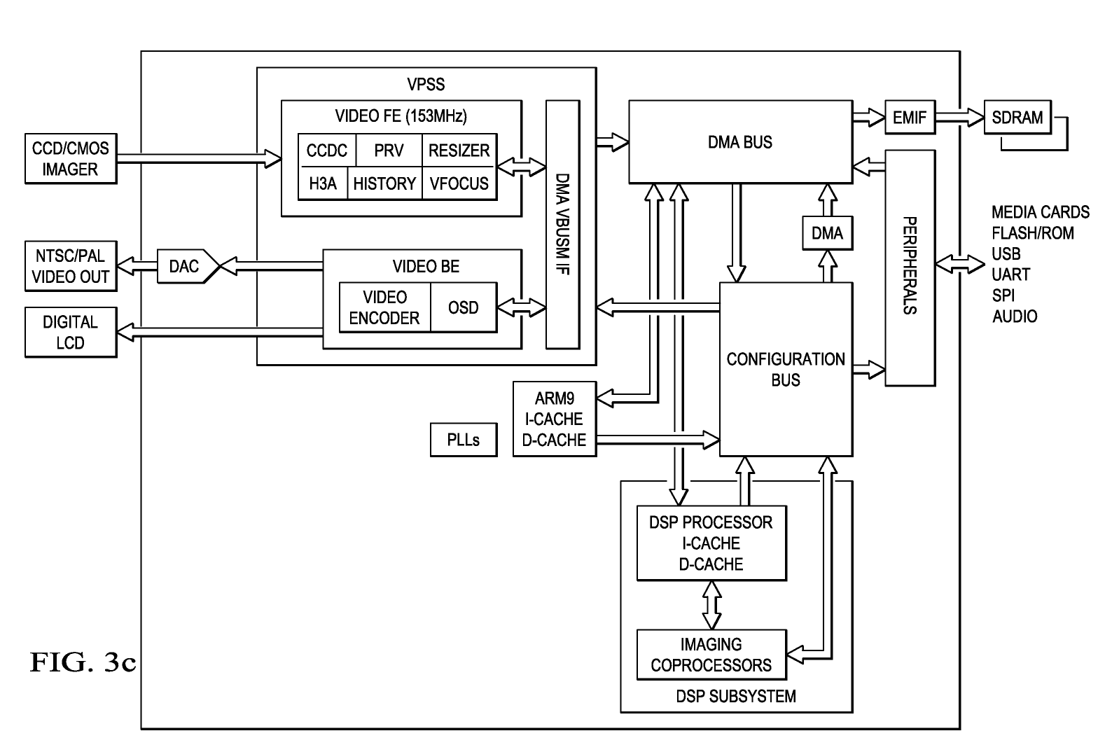

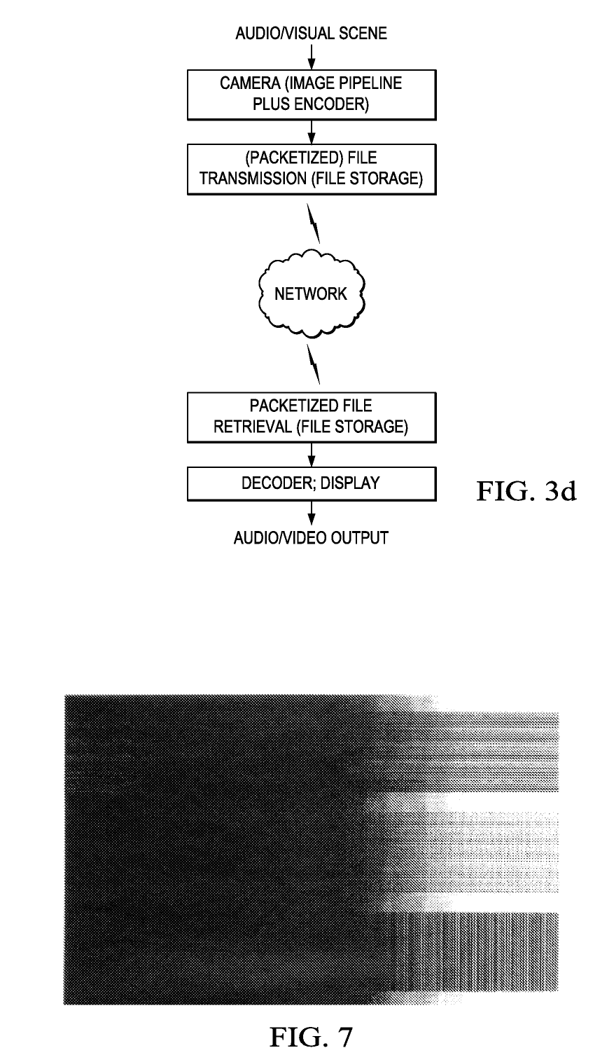

Preferred embodiment systems perform preferred embodiment methods with any of several types of hardware: digital signal processors (DSPs), general purpose programmable processors, application specific circuits, or systems on a chip (SoC) such as combinations of a DSP and a RISC processor together with various specialized programmable accelerators. FIG. 3c is an example of digital camera hardware. A stored program in an onboard or external (flash EEP)ROM or FRAM could implement the signal processing. Analog-to-digital converters and digital-to-analog converters can provide coupling to the real world, modulators and demodulators (plus antennas for air interfaces) can provide coupling for transmission waveforms, and packetizers can provide formats for transmission over networks such as the Internet; see FIG. 3d.

### 2. Mixing of High-Gain and Low-Gain Signals

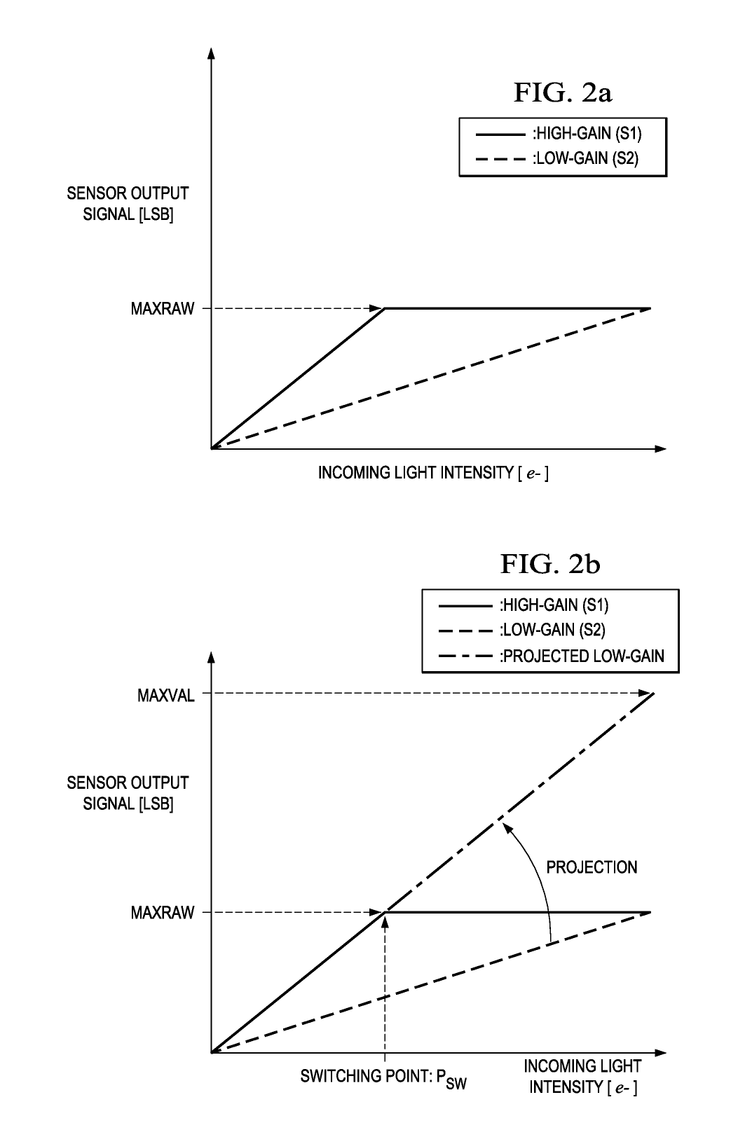

Consider the block diagram of image signal processing (ISP) for a wide dynamic range (WDR) sensor as shown in FIG. 1a. The only major difference between the WDR sensor ISP and the conventional sensor ISP (e.g., FIG. 3a) is the mixing process for the WDR ISP which is absent from the non-WDR ISP. The mixing process is to seamlessly mix S1 signals and S2 signals and comprises two main tasks: (1) calculate the relationship formula between S1 and S2 signals (as F(t) above) and (2) fit S2 signals into S1 axis by projecting S2 signals using the relationship formula while paying special attention to the seamless migration from S1 to S2 region around the transition area near MaxRaw; see FIG. 2b. Details of the preferred embodiments follow.

(1) Relationship Formula

As shown in FIG. 2b, the S2 gain curve linearly extends up to the saturation point, MaxRaw. On the other hand, the S1 gain curve is steeper than the S2 gain curve, and hence, gets saturated sooner than the S2 gain curve. On the assumption that both the S1 and S2 gain curves are linear, F(t)=f₂(t)+ can be derived. Now the problem to be solved here is to find the parameters gradient ( ) and offset ( ) of the relationship formula. There are three possible ways to achieve this task, each of which is detailed in one of the following subsections.

(a) Default Mode

In default mode the parameters and are fixed on a sensor device basis by the manufacturer, and are named default parameters. The default parameters will be determined based on statistical data that are usually obtained through testing actual devices or through experiments. We may have to set multiple default parameters in case the default parameters vary depending on environmental factors such as temperature. If these parameter sets can be expressed as a function of the environmental factors, the default parameters shall be provided accordingly so that memory (especially ROM) requirements can be relaxed. Otherwise, if the number of default parameters is relatively small, they can be implemented as a ROM table.

(b) On-the-Fly Mode

Use an on-the-fly determination of the S1-S2 relationship when the default mode is not applicable for some reason. In the on-the-fly mode, the relationship formula should be obtained from sensor output data, information, and whatsoever else is available at operation time. It is presumed that the most reliable source would be actual sensor outputs, i.e., S1 and S2 signals for the pixels of a captured image. The gain curves of S1 and S2 demonstrated in FIG. 2b imply that a relationship formula obtained in the non-saturation band of S1 (i.e., t<P_{SW}) would be a good estimator for the true relationship formula.

Among several ways to seek an optimal relationship formula, the method of least squares (MLS) is an efficient method for determining coefficients (parameters of the relationship formula in this case) to get the smallest possible mean square error. Another class of approximation techniques is the great variety of neural networks in which the underlying model is a connected net of functional units, and the unknown parameters are usually the weights of connections between these units. However, neural networks are not suited for real time, hence on-the-fly, applications as they require a large amount (usually unpredictable) of resources that cannot be afforded by such applications. Therefore, MLS-like schemes would be a reasonable choice. It shall be noted that MLS also consumes a considerable amount of resources (mostly computations). So WDR parameter determination would prefer to avoid such resource-hungry routines.

FIG. 1b shows the preferred embodiment determined relationship between collocated S1 and S2. The MLS calculation is carried out using observed S1 and S2 data in the non-saturation region; that is, lower than LowLinearMax (on S2 axis) that is specified at design time with a value: MaxRaw divided by design. It is usually observed that collocated pairs show a linear relation except at both extremes: near zero and near LowLinearMax, where collocated pairs do not have linearity (due to offset noise, etc.). Therefore, we remove such unreliable data from the source. In FIG. 1b Min and Max are set with some margin (e.g., a few percent of LowLinearMax) from zero and LowLinearMax, respectively.

Now we present a derivation of MLS, called selected representative MLS (SR-MLS), which is better suited for calculation of the S1-S2 relationship formula. SR-MLS is designed to estimate the best linear fit expression y=x+ for observed data, where x and y denote S2 and S1 data, respectively. Using all observed data (i.e., all the pixel data from a captured image) would not be the best choice because it requires a large amount of memory and computations and even hampers seeking the true relationship formula. Thus we apply SR-MLS with representative values (x₀, y₀), (x₁, y₁), . . . , (x_{N}, y_{N}), where the xⱼ are related as xⱼ₊₁=xⱼ+xᵢₙₜₑᵣᵥₐₗ (j=0,1, . . . , N 1). In this case Xᵢₙₜₑᵣᵥₐₗ means an interval on the x axis between two successive representative points and has the interval value (Max−Min)/N. The S1 value that correspond to xⱼ is represented by an average of S1 data whose collocated S2 signal is xⱼ. If no collocated pair exists at representative S2 point xⱼ, interpolation or extrapolation would be needed to derive a likely value for yⱼ from data whose S1 value fall near xⱼ. Note that a typical practical value would be N=10.

The SR-MLS has some merits because it is relatively simple and required computations are smaller than a plain MLS. Once the representative values are obtained, the SR-MLS is performed as follows. Presume the relational expression xⱼ=xᵢₙₜₑᵣᵥₐₗhⱼ+x₀ (j=1, . . . , N). This assumption is intended to relate the equally-spaced sequence xⱼ to the integer sequence hⱼ that ranges from 0 to N. Using this incremental relationship among the xⱼ transforms yⱼ=xⱼ+ into yⱼ=xᵢₙₜₑᵣᵥₐₗhⱼ+(x₀+). Thus, yⱼ can be represented as a function of hⱼ; namely, yⱼ=q(hⱼ).

In general, an arbitrary polynomial P(hᵢ) which has order m can be expressed as:

$$P ( {h}_{i} ) = {a}_{0} {P}_{N 0} ( {h}_{i} ) + {a}_{1} {P}_{N 1} ( {h}_{i} ) + … + {a}_{m} {P}_{Nm} ( {h}_{i} ) = {\sum }_{k = 0}^{m} {a}_{k} {P}_{Nk} ( {h}_{i} )$$

, where m<N, aₖ are coefficients of each term, and P_{Nk}(hᵢ) are orthogonal polynomials, which are defined as follows.

$${P}_{Nk} ( {h}_{i} ) = {\sum }_{l = 0}^{k} {( - 1 )}^{l} ( \begin{matrix}k \\ l\end{matrix} ) ( \begin{matrix}k + l \\ l\end{matrix} ) \frac{{( {h}_{i} )}^{( l )}}{{( N )}^{( i )}}$$

where the standard probability notation is used:

$$( \begin{matrix}a \\ b\end{matrix} )$$

denotes a binomial coefficient and (a)^{(b)} denotes a permutation number. Because of the orthogonality of the P_{Nk}(hᵢ), the a^{k} can be derived as follows, although the details of derivation are omitted here,

$${a}_{k} = \frac{{\sum }_{i = 0}^{N} P ( {h}_{i} ) {P}_{Nk} ( {h}_{i} )}{{\sum }_{i = 0}^{N} {P}_{Nk}^{2} ( {h}_{i} )} .$$

The P_{Nk}(hᵢ) are only dependent on N, k, and hᵢ, whose values are independent of the representative values. Incidentally, the numerical values of the P_{Nk}(hᵢ) and

$${\sum }_{i = 0}^{N} {P}_{Nk}^{2} ( {h}_{i} )$$

can be calculated beforehand and stored in memory prior to the calculation of the aₖ with instantaneous representative values. Thus, aₖ can be obtained by relatively simple calculations.

Now, let's consider the case of a linear function. P(hᵢ) can be rewritten as follows:

P(hᵢ)=a₀P_{N0}(hᵢ)+a₁P_{N1}(hᵢ)

where

$${P}_{N 0} ( {h}_{i} ) = 1 and {P}_{N 1} ( {h}_{i} ) = 1 - 2 \frac{{h}_{i}}{N}$$

are derived, respectively. Thus P(hᵢ) can be represented as follows, this is a more easily understandable expression,

$$P ( {h}_{i} ) = - \frac{2 {a}_{1}}{N} {h}_{i} + ( {a}_{0} + {a}_{1} ) .$$

because P(hᵢ) can be replaced with yᵢ=q(hᵢ) which is described above, eventually, we can obtain β and λ, that is,

$$β {x}_{interval} {h}_{i} + ( β {x}_{0} + λ ) = - \frac{2 {a}_{1}}{N} {h}_{i} + ( {a}_{0} + {a}_{1} ) ,$$

therefore

$$β = - \frac{2 {a}_{1}}{{Nx}_{interval}} , \\ and λ = {a}_{0} + {a}_{1} + \frac{2 {a}_{1} {x}_{0}}{{Nx}_{interval}} .$$

(c) Off-Line Mode

The off-line mode is intended for a mixture situation of the default mode and the on-the-fly mode. Typical cases would be (1) the default mode general works but calibration for adjusting the relationship formula to variable factors such as natural deterioration is needed, and (2) the on-the-fly mode works but cannot be performed every shot as it consumes too many resources. In such cases, users are required to calibrate periodically or when some indicator, if provided, warns that the default parameters do not work properly. We suppose that the method used for the on-the-fly mode can be exploited to calculate the parameters for the relationship formula. Then, the sought parameters replace old parameters (either default parameters or parameters obtained at previous calibrations).

(2) Fitting S2 Into S1 Axis

Once the relationship formula for S1-S2 signals is obtained, S2 signals are projected onto the S1 axis using the relationship formula as shown in FIG. 2b where the dotted line represents projected S2 signals. Thus we can obtain the output of the WDR sensor denoted by F(t) above. This version of F(t) is called hard-switching.

Another version for the mixing is called soft-switching and achieves gradual migration from S1 to S2 in a transition band, i.e., P_{SW}−<t<P_{SW}, where represents the range of the transition band and is a positive number (in units of [e−]). In the S1 non-saturation band (i.e., t<P_{SW}), both S1 and S2 signals are meaningful. A typical method to realize the gradual migration would be a weighted averaging denoted by g(t) and with 0<<1:

g(t)=f₁(t)+(1−)f₂(t)

Among the various derivatives of weighted averaging, a most practical implementation would be that of having weighting coefficients linear to distance from both ends of the transition band. The linearly weighted average gₗᵢₙ(t) is expressed by:

gₗᵢₙ(t)=[(P_{SW}−t)f₁(t)+(t P_{SW}+)(f₂(t)+)]/

In summary, the eventual output of the WDR sensor with soft-switching, denoted by F_{soft}(t), is expressed by:

$$\begin{matrix}{F}_{soft} ( t ) = {f}_{1} ( t ) & if t {P}_{SW} - \\ = {g}_{lin} ( t ) & if {P}_{SW} - < t {P}_{SW} \\ = {f}_{2} ( t ) + & if {P}_{SW} < t\end{matrix}$$

### 3. Mixing Noise Filtering

FIG. 1c shows functional blocks of a second preferred embodiment ISP for a WDR sensor which includes an adaptive filtering of the mixed high-gain and low-gain signals; this filtering addresses any noise generated by the mixing of the high-gain and low-gain signals. In particular, presume that the sensor noise is additive and is composed of shot noise and floor noise. The shot noise is proportional to t the square root of the incoming light intensity, while the floor noise is mainly caused by residual electrons at read-out timing and is independent of incoming light intensity. Generally, the shot noise and floor noise follow Gaussian distributions and are independent of each other. Let G(, ²) denote a Gaussian with mean, standard deviation, and thus variance ². Then let ₛₕₒₜ and _{floor} denote the standard deviations of the shot noise and the floor noise, respectively, where both are in units of [e−]. Theoretically, both shot noise and floor noise have mean equal 0, and the variance of the shot noise equals t. Thus the sum of the shot noise and floor noise has a Gaussian distribution G(0, ₛₕₒₜ²+_{floor}²)=G(0, t+_{floor}²). Let ₁² the variance of the floor noise for S1 and ₃² the variance of the floor noise for S2. Then the S1 and S2 signals including noise are:

f₁(t)=₁[t+G(0, t+₁²)]

f₂(t)=₂[t+G(0, t+₂²)]

Then the output is:

$$\begin{matrix}F ( t ) = 1 [ t + G ( 0 , t + {1}^{2} ) ] & if t Psw \\ = 2 [ t + G ( 0 , t + {2}^{2} ) ] + & otherwise\end{matrix}$$

Now ignoring and presuming has been sufficiently accurately calculated, so that =₁/₂, F(t) then becomes:

$$\begin{matrix}F ( t ) = 1 [ t + G ( 0 , t + {1}^{2} ) ] & if t Psw \\ = 1 [ t + G ( 0 , t + {2}^{2} ) ] & otherwise\end{matrix}$$

Thus when ₁=₂, there is no problem because the sensor output seamlessly transitions from the S1 domain to the projected S2 domain. But if ₁ ₂, especially if ₁ ₂, which mostly appears in actual devices, a discontinuity in noise level (so-called noise gap) appears at the switching point P_{SW}. This noise gap will bring quality deterioration and may occasionally result in visible artifacts in output images. In order to suppress the noise gap at P_{SW}, preferred embodiments apply a mixing noise reduction process as illustrated in FIG. 1c.

The mixing noise reduction needs to be applied only to the S2 signal (but not the S1 signal) because (1) ₁ ₂ holds for most actual devices and (2) in the concept of the mixing process, the S1 signal is the primary component of the WDR signal and should remain untouched as shown in FIG. 2b. The details of the mixing noise reduction appear in the following subsections.

(1) Concept of Mixing Noise Reduction Method

For mixing noise reduction, the conventional linear filter is one of the most effective ways because the floor noise, which is the main cause of the noise gap, has a Gaussian distribution. Here consider the population of the RGB vectors x_{(i,j)}=[x_{(i,j)0}, x_{(i,j)1}, x_{(i,j)2}] where x_{(i,j)k} indicates red for k=0, green for k=1, and blue for k=2 component values of pixel color at (i,j). The linear filter output at coordinates (s,t) in the kth color plane, which is denoted by y_{(,s,t)k}, is obtained as:

y_{(s,t)k}=_{(i,j)} w_{(i,j)k}x_{(i,j)k}

where w_{(i,j)k} are the filter weighting coefficients and is a neighborhood of (s,t).

This technique possesses mathematical simplicity but has some disadvantages. For example, it usually gives blurred edges if the input image contains subtle details. In this case, preferably apply an adaptive filter using the so-called map index designed to suppress noise while preserving details. The map indices can be shared with CFA interpolation processing to lessen computational complexity.

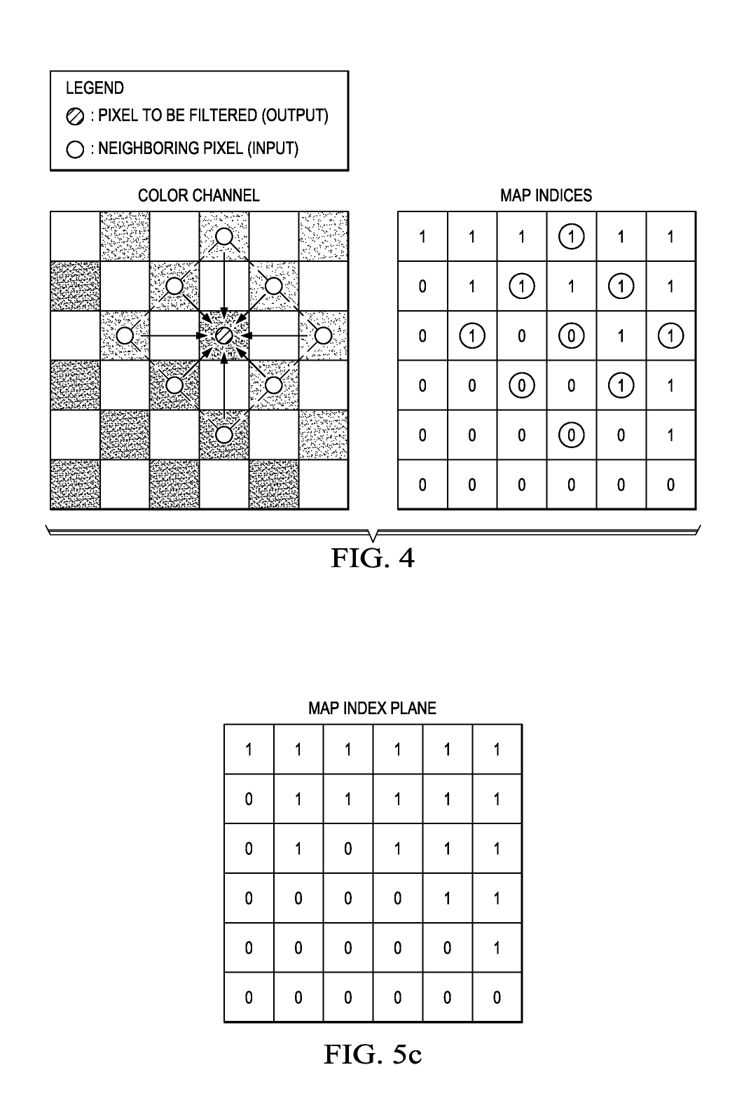

The map indices are a bit map where the value at each pixel indicates whether the pixel is relatively dark or relatively bright; for example, whether the pixel color component value is greater or less than the median in a neighborhood. Let _{(i,j)} denote the map index at coordinates (i,j). Once the map index is obtained, it is used as follows. FIG. 4 illustrates the adaptive filtering using the map index, where the pixel to be filtered is a dark pixel and is surrounded by six bright pixels and two dark pixels; the left panel of FIG. 4 shows the pixel plus eight neighbors in the color plane and the right panel shows the map indices with circles for the pixel and eight neighbors. The pixel to be filtered in FIG. 4 is a relatively dark pixel (map index 0), so larger weightings, w_{(i,j)k}, are applied to the two dark neighboring pixels than to the six bright neighboring pixels. This achieves a genuine adaptive filtering. On the other hand, in the case of a linear filter, larger weighting is applied to the six bright neighboring pixels rather than the two dark neighboring pixels as in the adaptive filtering scheme. This is because linear filtering is the weighted averaging of neighboring pixels, and the weighting coefficients are independent of the features of the pixels; that is, the two dark pixels are out-numbered by the six bright pixels in FIG. 4.

(2) Implementation of Mixing Noise Reduction Filtering

FIG. 1d is a block diagram of the mixing noise reduction adaptive filtering and shows the method to have two stages: (a) map index acquisition and (b) adaptive filtering. The preferred embodiment described in the following presumes Bayer pattern CFA input data.

(a) Map Index Acquisition

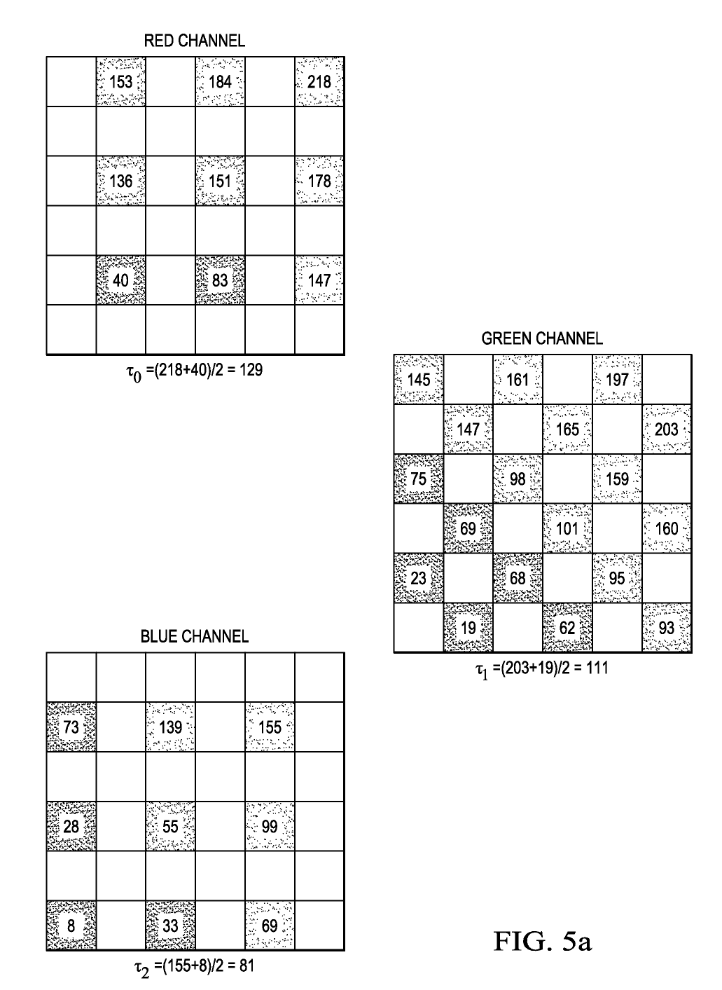

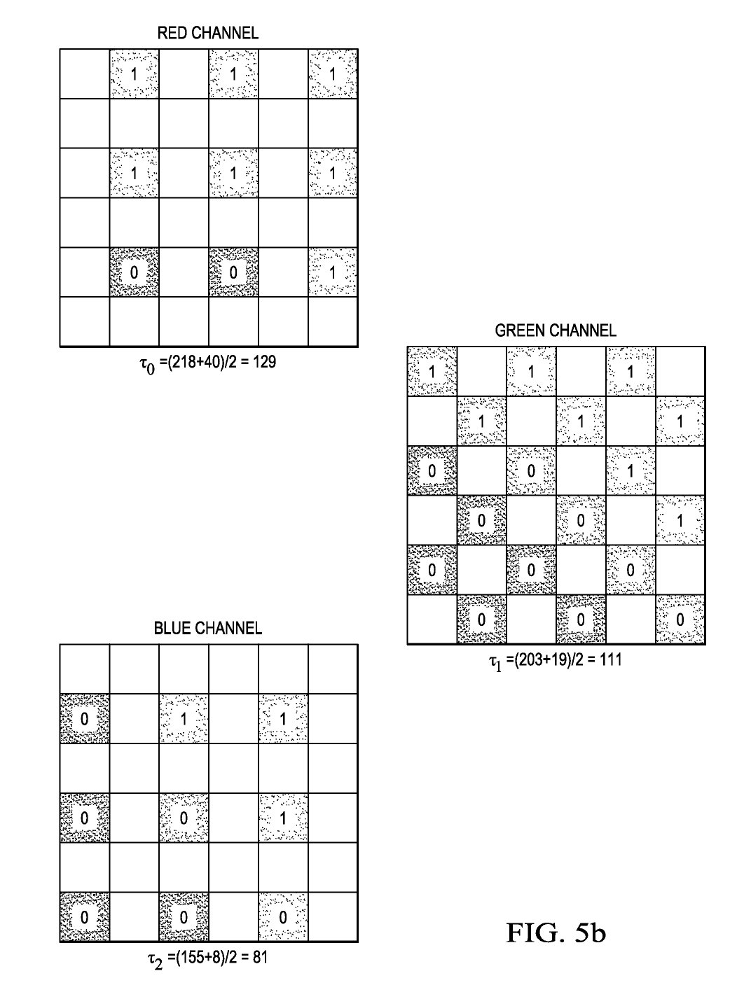

The map indices are obtained on a window basis with a threshold specific to the input data in the window (i.e., M×N block). In each window, a threshold value shall be determined first. In the illustration of FIGS. 5a-5c with 8-bit data (pixel color component values in the range of 0 to 255), the preferred embodiment employs middle of the signal dynamic range in a 6×6 block (M=N=6) as the threshold. Note that the threshold is set separately per each color component in a block. Let maxₖ and minₖ be the maximum and minimum values in a block for color k (k=0 is red, k=1 is green, and k=2 is blue). Define the corresponding three thresholds:

ₖ=(maxₖ+minₖ)/2

Now let _{(i,j)} denote the map index at coordinates (i,j). The map index _{(i,j)} is determined based on whether the pixel value x_{(i,j)k} is greater than the threshold or not:

$$\begin{matrix}( i , j ) = 1 & if {x}_{( i , j )} k > k \\ = 0 & otherwise\end{matrix}$$

The map indices are not dependent upon color component, so they can be integrated onto one plane; see FIGS. 5b-5c.

(b) Adaptive Filtering Using Map Index

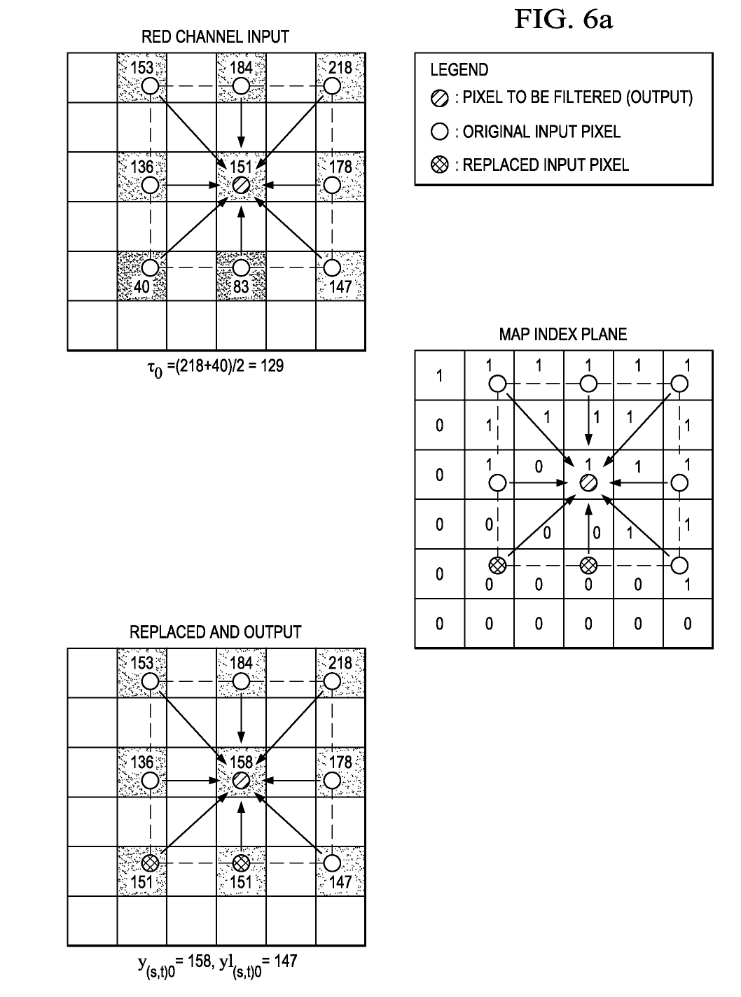

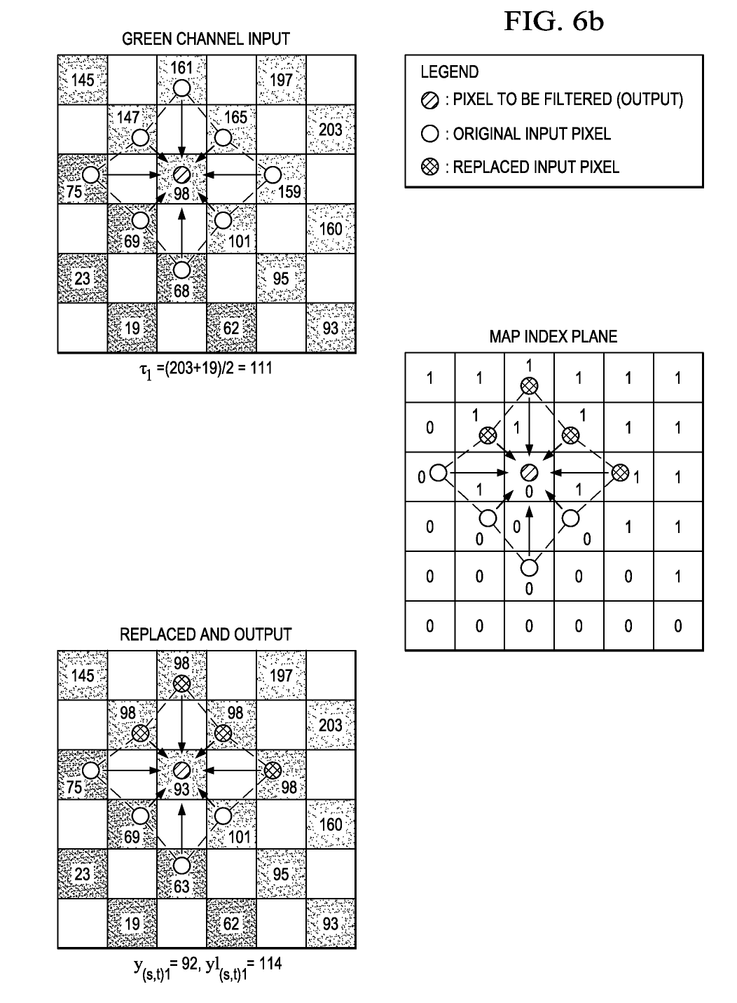

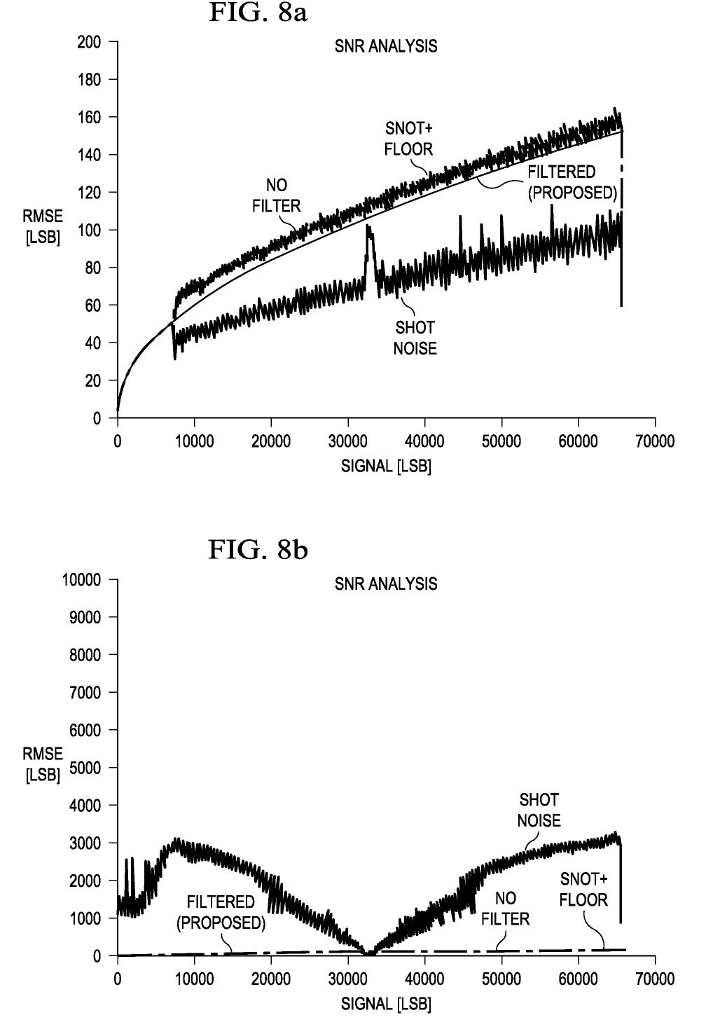

Once the map indices are obtained, an adaptive filter is applied to all relevant pixels in the window (i.e., M×N pixel block). The tasks are two-fold: (1) input data update and (2) linear filtering. Now consider what information the map indices provide. The preferred embodiment methods rely on the characteristics of the map indices (i.e., a relative gray level classification) for a strategy of: when a pixel is to be filtered using neighboring pixels which have the same color as the pixel to be filtered, whole weights are applied to the neighboring pixel values that have the same map index. On the other hand, the pixels that have the opposite map index are not used for the filtering and instead their values are replaced with the center pixel value (i.e., the pixel to be filtered). This replacement process has two branches (i) if the input pixel (i.e., original input) has the same map index with the pixel to be filtered, the pixel value is used as input and (ii) if the input pixel has the opposite map index with the pixel to be filtered, the pixel value is replaced with the value of the pixel to be filtered. An example of this process is illustrated in FIGS. 6a-6b.

The adaptive filter means that the linear filter in FIG. 1d is processed for input data after the replacement process. Now let x_{(i,j)k} denote the replaced input pixel whose coordinate is (i,j) and color plane is the k-th. In the case of k=0 or k=2 (red or blue planes), take the filter neighbor at (s,t) to be ={(s 2,t 2), (s,t 2), (s+2,t 2), (s 2,t), (s,t), (s+2,t), (s 2,t+2), (s,t+2), (s+2,t+2)} as indicated in FIG. 6a. The right panel of FIG. 6a shows the replaced x_{(i,j)k} except the case of (i,j)=(s,t) and the output denoted by y_{(i,j)k} when w_{(i,j)k}={1,1,1,1,8,1,1,1,1}/16 where y_{(i,j)k} is rounded to the nearest integer. In the case of k=1 (green plane), ={(s,t 2), (s 1,t 1), (s+1,t 1), (s 2,t), (s,t), (s+2,t), (s 1,t+1), (s+1,t+1), (s,t+2)} as indicated in FIG. 6b in a similar fashion. The right panel of FIG. 6b shows the replaced x_{(i,j)k} except the case of (i,j)=(s,t) and the output denoted by y_{(i,j)k} when w_{(i,j)k}={1,2,1,2,4,2,1,2,1}/16, where y_{(i,j)k} is rounded to th nearse integer. Also, yl_{(i,j)k} in the bottom of the figure denotes the output of linear filter (i.e., no replacement).

Here note that the adaptive filtering is more effective when the input image contains subtle details. On the other hand, when the input image is homogeneous, the linear filter is rather more effective, hence, desired. In order to measure whether the input image is homogeneous or not, an arbitrary range threshold level in the k-th color plane, which is denoted by rthₖ, is compared with (maxₖ+minₖ). If rthₖ>(maxₖ+minₖ), the input image is assumed to be homogeneous, i.e., there is no significant distinction between dark and bright pixels. In such a case, the in a window are all forced to be zero; that is, no data is replaced in FIG. 6a-6b, and thus the linear filtering is applied.

### 4. Experimental Results

This section examines the the performance of the preferred embodiment mixing methods. In order to obtain the S1-S2 relationship formula, the on-the-fly mode that employs an SR-MLS scheme was tested. Simulations were conducted with the parameters as shown in the following table, where we assume that S1 and S2 have different noise levels, as likely in actual devices, in terms of the floor noise.

| resolution [pixels] | 3640x2400 |
|---|---|
| MaxRaw [LSB] | 8191 (13 bits) |
| ₁ [LSB/e-] | MaxRaw/23000 |
| ₂ [LSB/e-] | MaxRaw/184000 |
| MaxVal [LSB] | 65535 (16 bits) |
| S1 floor noise [e-] | 10 |
| S2 floor noise [e-] | 80 |

Test data was synthetically generated. First, we created a test image that is basically a set of monochrome gradations (varying horizontally from zero to full range) and contains many small rectangular objects, with object gray value equal to half of the full dynamic range (this is called the monochrome pattern signal), as shown in FIG. 7. Then, input light intensity data associated with the test image were calculated by applying an inverse of the sensor's conversion of light to signal. Finally, collocated pair data were derived taking into account the ratio of signal (i.e., input light intensity) to noise (shot noise plus floor noise).

The experimental results are shown in FIGS. 8a-8b, where the horizontal axis shows output signal and the vertical axis indicates noise level in root mean square error (RMSE). Theoretical curves of shot noise (lower curve) and shot plus floor noise (upper curve) are depicted in FIG. 8a with the noise gap around the switching point of 8000 [LSB] (lower left in FIG. 8a) appearing as a discontinuity in the shot plus floor noise curve. The noise gap is caused by the difference between S1 floor noise and S2 floor noise. The upper rapidly-varying trace in FIG. 8a shows the simulation results that represent the difference between the original synthetic test image and its simulated output after the mixing process. Thus the primary comparison should this upper trace and the upper curve. By applying the preferred embodiment adaptive filter to the simulated output, the lower rapidly-varying trace in FIG. 8a is obtained.

In FIG. 8a, which shows the results when the preferred embodiment adaptive filter is applied, the suppression of S2 floor noise is sufficient and successful, that, the lower rapidly-varying curved lies below the shot noise level in the projected S2 region (past the switching point on the horizontal axis). On the other hand, in FIG. 8b, the noise suppression by linear filtering fails because the noise level even increases far beyond the shot noise level over nearly the entire incoming lighter intensity range. We conclude that the preferred embodiment adaptive filter would work effectively for reducing mixing noise. Especially when the input image contains subtle details, the preferred embodiment adaptive filter significantly outperforms plain linear filtering.

What is claimed is:

1. A method for wide dynamic range (WDR) sensor output, comprising:
(a) providing plurality of collocated high-gain output and low-gain output pairs for pixels in an image captured by a WDR sensor;
(b) selecting a subplurality of said plurality where low-gain outputs in said subplurality are separated by multiples of an output interval and said high-gain outputs are less than a saturation value;
(c) computing by least squares a linear relationship between said high-gain outputs and said low-gain outputs for said subplurality; and
(d) mixing said high-gain outputs and said low-gain outputs of said plurality according to said linear relationship to form a WDR sensor output.

2. The method of claim 1, wherein said mixing includes a soft transition about pairs with said high-gain output within a threshold of saturation.

3. A method for wide dynamic range (WDR) sensor output, comprising:
(a) providing plurality of collocated high-gain output and low-gain output pairs for pixels in an image captured by a WDR sensor;
(b) providing a linear relationship between said high-gain outputs and said low-gain outputs;
(c) mixing said high-gain outputs and said low-gain outputs according to said linear relationship to form a WDR sensor output; and
(d) adaptively filtering said WDR sensor output, said adaptive filtering includes the steps of:
(i) indexing the pixels by comparison of the WDR sensor output for a pixel to the WDR sensor outputs for the same color pixels in a neighborhood;
(ii) for a target pixel, replacing the WDR sensor output for each pixel in a filter neighborhood of the target pixel with the WDR sensor output of the target pixel when the index of said each pixel differs from the index of the target pixel; and
(iii) linearly filtering at the target pixel; and
(iv) repeating (ii)-(iii) with the target pixel replaced by other pixels of the WDR sensor output image.
